(19) United States
(12) Patent Application Publication
(10) Pub. No.: US 2009/0289046 A1
(43) Pub. Date: Nov. 26, 2009

(54) Heated Garment

(76) Inventor: Simon Nicholas Richmond, Princeton, NJ (US)

Correspondence Address: LAW OFFICES OF DONALD COX, P.O. BOX 505, PRINCETON, NJ, 08542-0505, US

(21) Appl. No.: 12/472,360

(22) Filed: May 26, 2009

Related U.S. Application Data
(60) Provisional application No. 61/128,674, filed on May 23, 2008.

(51) Int. Cl. H05B 1/00; A41D 27/20; A41D 27/02; H01M 2/00

(52) U.S. Cl. 219/211; 2/247; 2/272; 429/61

(57) ABSTRACT

The present invention relates to a garment assembly including an outer layer selected from any separately manufactured outer layer and a liner covering an inner surface of the outer layer. The inner layer includes a fabric layer, at least one flexible heating element affixed to the fabric layer, a controller electrically connected to the heating element, a portable power supply electrically connected to the controller and the heating elements; electrical leads affixed to the fabric layer to provide an electrical connection between the portable power supply, the controller and the at least one heating element, and at least one closeable pocket for housing the controller and the portable power supply. The present invention further relates to a rechargeable battery pack for seasonal use in a heated garment having at least one battery and battery control circuit having a current drain on said at least one battery maintained within a self-contained housing. The battery further includes a switch located between the battery and battery control circuit operative to, during long periods of non-use, create an open circuit between the battery and the battery control circuit.

### CROSS REFERENCE TO RELATED APPLICATION(S)

This application is related to, and claims priority from, U.S. Provisional Patent application No. 61/128,674 filed on May 23, 2008 entitled “Heated garment”, the contents of which are hereby incorporated by reference.

### BACKGROUND OF THE INVENTION

1. Field of the Invention

This application relates generally to electrically heated apparel and, in particular, to electrically heated garments having heating components associated with the lining of the garments.

2. Description of Related Art

The present invention pertains to heating the body of an individual and more particularly relates to an electrically heated garment with temperature control.

All sorts of clothes on the market can generally divided into two categories: cold weather clothing and warm weather clothing. During freezing winter conditions, no matter what insulative clothes a person puts on, they can still feel cold. One solution to this problem is to dress in layers. This solution often results in the person being weighted down with very limited range of motion. This limited range of motion often contributes to remaining cold due to lack of movement. Additionally, many people do not have access to, or storage for, the amount of clothes sometimes necessary in the cold winter months. The present invention seeks to provide a device that solves all of the aforementioned problems by providing external heat as well as insulation.

The use of garments with heating sources is known in the prior art. More specifically, garments with heating sources heretofore devised and utilized for the purpose of providing warmth to the body are known to consist basically of familiar, expected and obvious structural configurations, notwithstanding the myriad of designs encompassed by the crowded prior art which have been developed for the fulfillment of countless objectives and requirements.

While such devices fulfill their respective, particular objective and requirements, the aforementioned prior art do not solve all the problems associated with the effective design and quality and cost effective manufacturing of a heated garment for heating the body of an individual.

An electrically heated garment is typical subject to a physical environment that is more extreme than most other type of heating devices. Being portable and worn on a body, it is subject to environment forces such as impact, stretching, twisting, vibration, washing and drying and abrasion. Accordingly, a certain level of electrical design and manufacturing skill combined with garment design and manufacturing skill are required to design and construct a heated garment in a manner that minimizes the risk of product failure (i.e. failing to heat) and also catastrophic failure such as an electrical short that results in the garment overheating and potentially injuring the wearer or the property of the wearer. Thus, an improved design and manufacturing process that can ameliorate most of these risks is desired. Furthermore, cold weather garments are considered seasonal in many regions of the world. Thus, the need exists for heated garments that reduce maintenance and have an increased life cycle due to improvements to prolong the life cycle of the rechargeable power supply used with the garment during storage.

Therefore, it can be appreciated that there exists a continuing need for new and improved heated garment that can be used for heating the body of an individual. In this regard, the present invention substantially fulfills this need.

### BRIEF SUMMARY OF THE INVENTION

The present invention relates to a garment assembly including an outer layer selected from any separately manufactured outer layer and a liner covering an inner surface of the outer layer. The inner layer includes a fabric layer, at least one flexible heating element affixed to the fabric layer, a controller electrically connected to the heating element, a portable power supply electrically connected to the controller and the heating elements; electrical leads affixed to the fabric layer to provide an electrical connection between the portable power supply, the controller and the at least one heating element, and at least one closeable pocket for housing the controller and the portable power supply.

The present invention further relates to an inner liner for attachment to an outer garment layer including a fabric layer, at least one flexible heating element affixed to the fabric layer, a controller electrically connected to the heating element, a portable power supply electrically connected to the controller and the heating elements; electrical leads affixed to the fabric layer to provide an electrical connection between the portable power supply, the controller and the at least one heating element, and at least one closeable pocket for housing the controller and the portable power supply. Wherein a heated garment is provided solely within the layer of a garment.

The inner layer further including a plurality of strain reliefs to protect the integrity of the electrical circuit.

The inner layer further including a pocket having a closeable opening for holding the controller. In one instance the opening includes two opening positions where the first opening position is an opening large enough for access to the controller and a second opening position is large enough for insertion and connection of the controller.

In an alternate embodiment a pocket for the controller includes a portion formed from material having light transmissive properties.

The present invention further relates to a rechargeable battery pack for seasonal use in a heated garment having at least one battery and battery control circuit having a current drain on the at least one battery maintained within a self-contained housing. The battery further includes a switch located between the battery and battery control circuit operative to, during long periods of non-use, create an open circuit between the battery and the battery control circuit.

### BRIEF DESCRIPTION OF THE DRAWINGS

FIG. 1A is a schematic view of a heated garment in accordance with the preferred embodiment of the present invention.

FIG. 1B is a schematic enlarged view of part of FIG. 1A.

FIG. 2 is a schematic view of a controller module used in the preferred embodiment of the present invention as shown in FIG. 1A.

FIG. 3A is a schematic surface view of the front of the garment in accordance with the preferred embodiment of the present invention as shown in FIG. 1A.

FIG. 3B is a schematic surface view of the back of the garment in accordance with the preferred embodiment of the present invention as shown in FIG. 1A.

FIG. 4A is a schematic view of the garment connectors in accordance with the preferred embodiment of the present invention of FIG. 1A.

FIG. 4B is an alternate schematic view of the garment connectors of FIG. 4A with the connector cap in a closed position.

FIG. 5 is a schematic view of the controller connectors and garment connectors used in the preferred embodiment of the present invention as shown in FIG. 1A.

FIG. 6A is a schematic view of the battery pack in accordance with the preferred embodiment of the present invention of FIG. 1.

FIG. 6B is an alternate schematic view of the battery pack of FIG. 6A.

FIG. 7A is a schematic view of the battery pack of FIG. 6A in use and in accordance with the preferred embodiment of the present invention of FIG. 1A.

FIG. 7B is a schematic view of the battery pack of FIG. 6B when charging in accordance with the preferred embodiment of the present invention of FIG. 1A.

FIG. 8 is a perspective schematic view of the winged strain relief in accordance with the preferred embodiment of the present invention of FIG. 1A.

FIG. 9 is a schematic view from above of the winged strain relief of FIG. 8.

FIG. 10A is a cross-sectional view of a portion of the preferred embodiment of the present invention of FIG. 1A.

FIG. 10B is a cross-sectional view of a portion of a second embodiment of the present invention.

FIG. 11 is a schematic view of the controller pocket zipper in accordance with the preferred embodiment of the present invention as shown in FIG. 1B.

FIG. 12A is a alternate schematic view of the controller pocket zipper in accordance with the preferred embodiment of the present invention as shown in FIG. 11.

FIG. 12B is a alternate schematic view of the controller pocket zipper in accordance with the preferred embodiment of the present invention as shown in FIG. 12A.

FIG. 13 is a cross sectional view of the garment in accordance with a third embodiment of the present invention as shown in FIG. 1.

FIG. 14 is a cross sectional view of the garment in accordance with the third embodiment of the present invention as shown in FIG. 13.

FIG. 15A is a schematic view of a grommet in accordance with the third embodiment of the present invention as shown in FIG. 13.

FIG. 15B is a schematic view of part of a garment in accordance with the third embodiment of the present invention of FIG. 13.

FIG. 16 is a schematic view of a wireless controller in accordance with a fourth embodiment of the present invention of FIG. 1.

FIG. 17A is a prior art partial circuit diagram of a prior art battery pack.

FIG. 17B is a partial circuit diagram of the battery pack in accordance with the preferred embodiment of the present invention as shown in FIGS. 6A, 6B, 7A and 7B.

FIG. 17C is a partial schematic and circuit diagram of the heating system in accordance with the preferred embodiment of the present invention as shown in FIGS. 1 and 17B.

FIG. 17D is a diagram of part of the charging and discharging sub-system in accordance with the preferred embodiment of the present invention as shown in FIG. 17B.

FIG. 18A is a schematic view of a first alternate battery pack in accordance with a fifth embodiment of the present invention.

FIG. 18B is an alternate schematic view of the battery pack of FIG. 18A.

FIG. 19 is an alternate embodiment of a controller pocket.

### DETAILED DESCRIPTION OF THE INVENTION

A preferred embodiment and alternative embodiments of the present invention will now be described by reference to the accompanying drawings in which, as far as possible, like numbers represent like elements.

Many apparel companies outsource part or all of their apparel production to experienced specialist factories in countries where the cost of the high labor content of sewing and assembling a jacket or vest is substantially lower than in the United States. A quick review of outdoor winter clothing retailers' shelves shows that many of the well-known market brands have winter apparel made in countries such as Vietnam, Thailand and China. This outsourcing is due primarily due to fierce price competition in the U.S. market and the flexibility to scale up rapidly through the use of excess capacity in multiple contractor factories. Further, this offshore outsourcing reduces catastrophe and sovereign risk by being able to source apparel from different factories and countries.

In mass production, experienced electrical staff can assemble the electrical portions of the heated garment. However, a high level of capacity, expertise and cost competitiveness in garment manufacturing is infrequently found co-located with a high level of capability and expertise in electrical manufacturing and assembly. A heated garment requires the combination of both types of manufacturing. Sending electrical heating components to a garment factory for sewing into a garment is fraught with risk as the garment factory staff usually have little experience with electrical items and may accidentally damage the electrical parts through poor design and poor production processes. For example, while sewing the electrical wires into a jacket, a garment worker may accidentally run a sewing needle through a wire, creating a potential region of increased electrical resistance and thus heat. The lack of electrical expertise in the garment facility may result in such a defect not being detected during the quality assurance process of the garment finishing. The preferred embodiment of the present invention facilitates a method of manufacture that minimizes such risks.

Further, fashion changes necessitate rapid changes to garment design. It is undesirable to redesign the physical electrical layout and connections to accommodate rapid and frequent changes in outer garment design. The preferred embodiment of the present invention facilitates freedom of design of the outer garment with little required consideration for the layout of the heating components and controls and thus allow the heating components to be built into a myriad of existing garment designs.

It has become popular in recent years to utilize layering in the design of performance outerwear. For example, in mid-2007, catalog retailer L. L. Bean marketed a Storm Chaser™ 3-in-1 Jacket that can be worn three ways to seal out the cold, water and wind. It has an outer nylon water resistant shell jacket with a zipper front and an insulating polyester fleece liner jacket that can mate the zipper on the shell with the zipper on the fleece liner jacket. With this construction (1) the outer shell can be worn separately, or (2) the fleece liner jacket can be worn separately, or (3) the liner jacket can be worn in combination with the outer shell to create an insulated water-resistant jacket.

Current heated jacket designs have control access and/or battery pack access from the outside of the jacket such as on a sleeve, on an outer chest area or in an outer pocket. These construction methods would be not be suitable for use in the shell/fleece liner combination jacket design outlined above as the controls or battery pack would not be easily accessible as they would be below the surface of the outer shell. The preferred embodiment of the present invention overcomes this problem by having all user operable parts easily accessible from the interior of the lining of the liner jacket.

In this respect, the heated garment with temperature control according to the present invention substantially departs from the conventional concepts and designs of the prior art, and in doing so provides an apparatus primarily developed for the purpose of heating the body of an individual.

The present invention relates generally to electrically heated apparel and, in particular, to electrically heated garments having heating components associated with the lining of the garments. It should noted that the term garment is not intended to be limiting, but may be interpreted broadly to include any item for insulating or keeping warm a living body including head wear, foot wear, socks, gloves, seating cushion, etc.

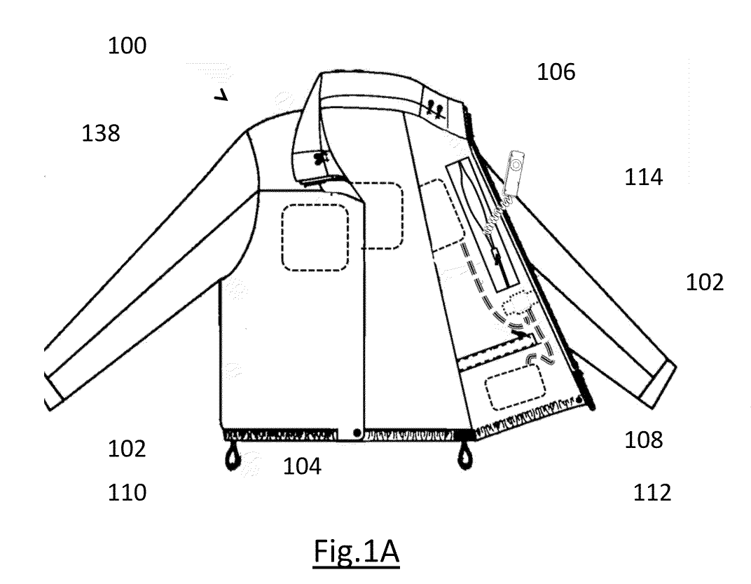

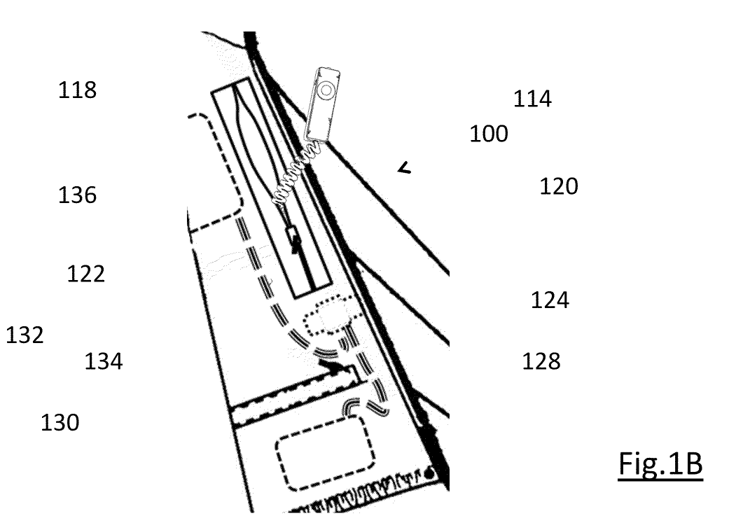

FIG. 1A is a schematic view of a heated garment 100 in accordance with the preferred embodiment of the present invention. The heated garment 100 as shown in FIG. 1A is a jacket with an exterior garment surface 138, a lining having a lining outer surface 104, sleeves 102 and a collar 106. The jacket preferably has a releasable seal such as, but not limited to a zipper, snaps or buttons for purposes of illustration a central zipper is shown for closing the jacket and trap heat around the wearer's body. Such jackets typically have a lower hem 110 with elastic material and/or an elastic cord running there through that is tightened by a tightening cord 112 to trap heat around the wearer. Inside the interior of the jacket are at least two user-accessible pockets. One pocket is a lining pocket 108 for holding a battery pack, while the second pocket is a controller pocket 118. It will be appreciated by those skilled in the art that a single pocket with organizer walls not shown) may be substituted for the two pockets without detracting from the present invention. Preferably the outer garment fabric is two layers of dense polyester fleece with a TPU (thermal polyurethane) layer between such that the three layers are bonded together. This fabric has several advantages for a heated garment. Firstly, the two layer fleece and TPU layer effectively reduce heat loss from “wind chill” as it substantially reduces airflow. Secondly, because the fleece layers are water-permeable and the TPU layer allows moisture such as perspiration to pass outwardly through the fabric, excess moisture can be wicked away from the body. A major cause of feeling cold is when a person undertakes an activity that causes exertion such that perspiration is created. When that activity ceases and the body cools, perspiration evaporatively cools the body. By allowing such perspiration to move away from the body and out of the garment, this evaporative cooling effect is minimized. Additionally, the TPU layer prevents water such as from rainfall to soak through into the garment and cause a similar evaporative cooling effect. These three layers create a good insulation layer to trap much of the heat generated by the heated garment and the wearer so that the heating functions can be turned down or off thus extending the battery life and thus the hours of operation required before recharging the battery pack. The three layers although warm, are not bulky and facilitate the wearing of the garment as a middle layer in a garment layering solution further improving the insulation of the system.

FIG. 1B is a schematic enlarged view of part of the heated garment 100 in FIG. 1A. It shown the lining pocket 108 has a battery pack pocket opening 132 through which a battery pack 130 can be inserted into the pocket 108. The controller pocket 118 preferably located in an upper chest region for ease of access holds a user-operable hand controller 114 for adjusting the heat level output of the heated garment 100. The output of the controller supplies power to the heating elements of the garment such a heating element region 136 in the chest area via a heating element power supply cable 134. The input of the controller 114 receives power from the battery pack 130 via a power supply input cable 128. Both the input and the output cables of the controller 114 exit the controller pocket 118 to an internal region of the garment 100 at a lower controller pocket region 120. Both the heating element power supply cable 134 and the power supply input cable 128 are firmly retained to the fabric lining by their integration into a winged cable strain relief 124 that is preferable sewn into the inner lining of the garment 100. The controller is accessed via a controller pocket zipper 122 which opens the controller pocket.

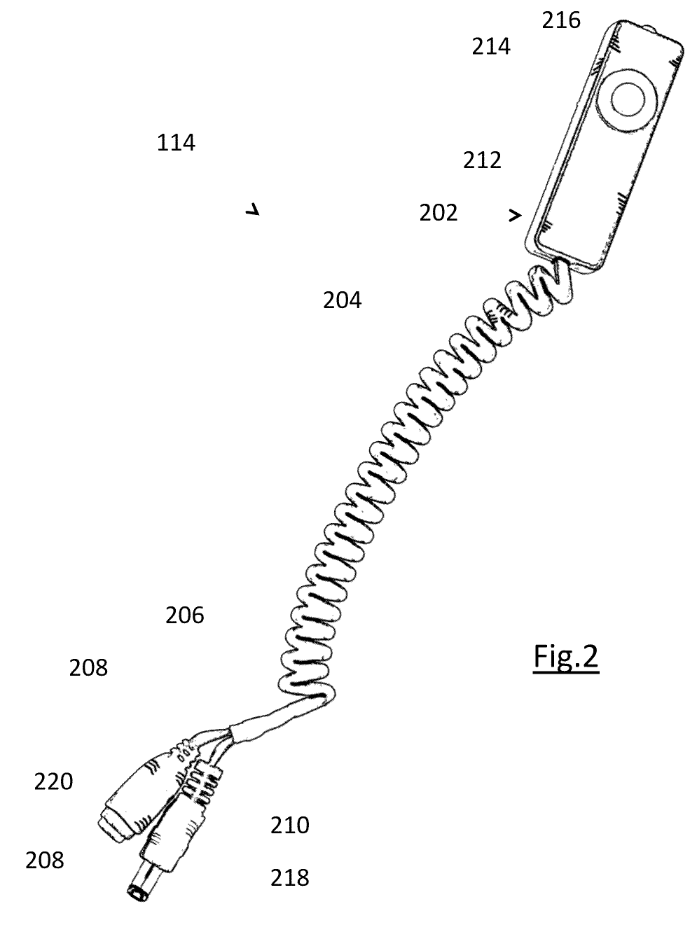

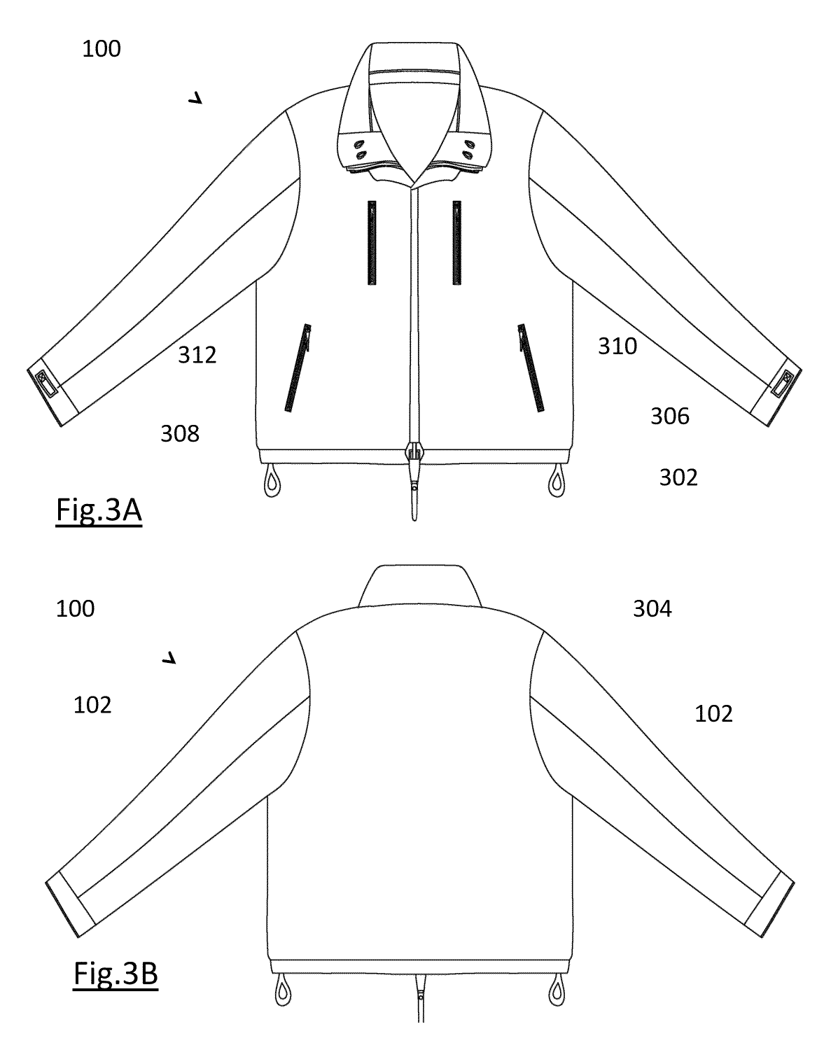

FIG. 2 shows a schematic view of a controller 114 used in the preferred embodiment of the present invention as shown in FIG. 1A. FIG. 3 shows a schematic view of the controller connectors of the controller 114 of FIG. 3. As shown in greater detail in FIGS. 2 and 3, the controller 114 comprises a controller body 202, a space saving cable 204, such as a resilient stretchable curly cord cable or a spring biased retractable cord ending at a controller heat shrink 206 region and diverging into a controller power input plug 210 and a controller power output socket 208. The controller body 202 has a controller housing 212 made of a lightweight material such as ABS thermoplastic, a controller user-operable button 214 for varying the heat level and an controller indicator light 216 that has tri-color light emitting diode inside so it can provide a visual feedback of the heat level. Presently the tri-color LED includes red, orange and green for ease of view and availability, but other color combinations may be used or other indicating means such as, but not limited to, separate lights, sounds or vibrations or a combination thereof to signal the status of the controller.

Controller Operation

When the power is provided to the controller 114 via the controller power input plug 210 and the controller user-operable button 214 is depressed once, the controller indicator light 216 illuminates and displays a red color. Internally, a circuit within the controller housing 212 allows a maximum predetermined current to pass through the controller 114 and out through the controller power output socket 208 to the heating elements. This is termed the “HIGH” level of heat setting. When the controller user-operable button 214 is depressed a second time, the controller indicator light 216 illuminates and displays an orange color. Internally, the circuit pulses in a timed manner, the current passing out through the controller 114 and out through the controller power output socket 208 to the heating elements. This is termed the “MEDIUM” level of heat setting. When the controller user-operable button 214 is depressed a third time, the controller indicator light 216 illuminates and displays a green color. Internally, the circuit within the controller housing 212 circuit pulses in a timed manner with a wider pulsing “off” time, the current passing out through the controller 114 and out through the controller power output socket 208 to the heating elements. This is termed the “LOW” level of heat setting. When the controller user-operable button 214 is depressed a fourth time, the controller indicator light 216 ceases to illuminates. Internally, the circuit within the controller housing 212 cuts the current flowing to the heating elements. This is termed the “OFF” setting. The control cycle may be repeated by continued depressing of the controller user-operable button 214.

FIGS. 3A and 3B are a schematic surface view of the front and back of the garment 100 in accordance with the preferred embodiment of the present invention as shown in FIG. 1A. As shown in FIGS. 3A and 3B, the preferred embodiment of the garment 100 has a plurality of zippered external pockets in the external front garment face 302. There may also be other pockets on the external back garment face 304. There is shown an external lower left hand pocket 306 and an external lower right hand pocket 308 for item storage and keeping hands warm. There is also a zippered external upper left napoleon pocket 310 and a zippered external upper right napoleon pocket 312. There may be more or fewer pockets in other embodiments according to the desired outer garment design.

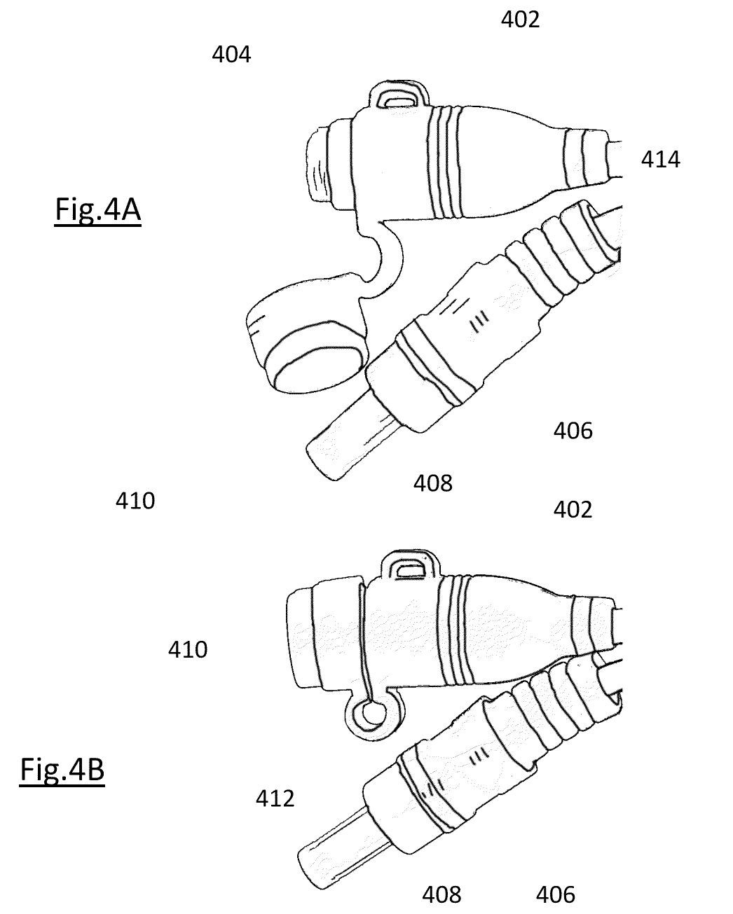

FIG. 4A is a schematic view of the garment connectors in accordance with the preferred embodiment of the present invention of FIG. 1A. FIG. 4B is an alternate schematic view of the garment connectors of FIG. 4A with the connector cap in a closed position. FIGS. 4A and 4B shows a garment power input plug 406 having a garment power input plug tip 408 and garment power input cable strain relief 414. It also shows a garment power output socket 402 having a garment power output socket aperture 404 which has a detachable garment power output socket cap 410 secured to the garment power output socket 402 via a garment power output cap retainer loop 412. This cap may be used to cover the garment power output socket aperture 404 when the garment is washed to protect same from damage.

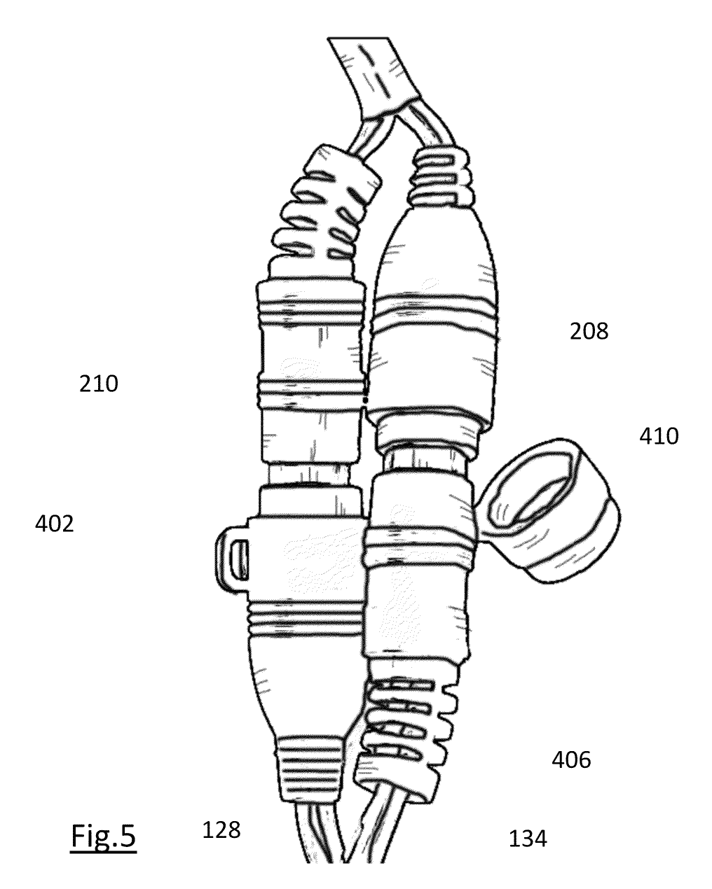

FIG. 5 is a schematic view of the controller connectors 208 and 210 connected to the garment connectors 402 and 406 used in the preferred embodiment of the present invention as shown in FIG. 1A. When in use, the controller power input plug 210 is plugged into the garment power output socket 402 and the adjacent garment power input plug 406 is plugged into the controller power output socket 208 with the garment power output socket cap 410 detached from the garment power output socket 402. Thus power is supplied from the battery pack to the controller 114 (not shown) via the power supply input cable 128, the garment power output socket 402 and the controller power input plug 210. Power is supplied to the heating element power supply cable 134 through the controller 114 (not shown) via the controller power output socket 208 and the garment power input plug 406.

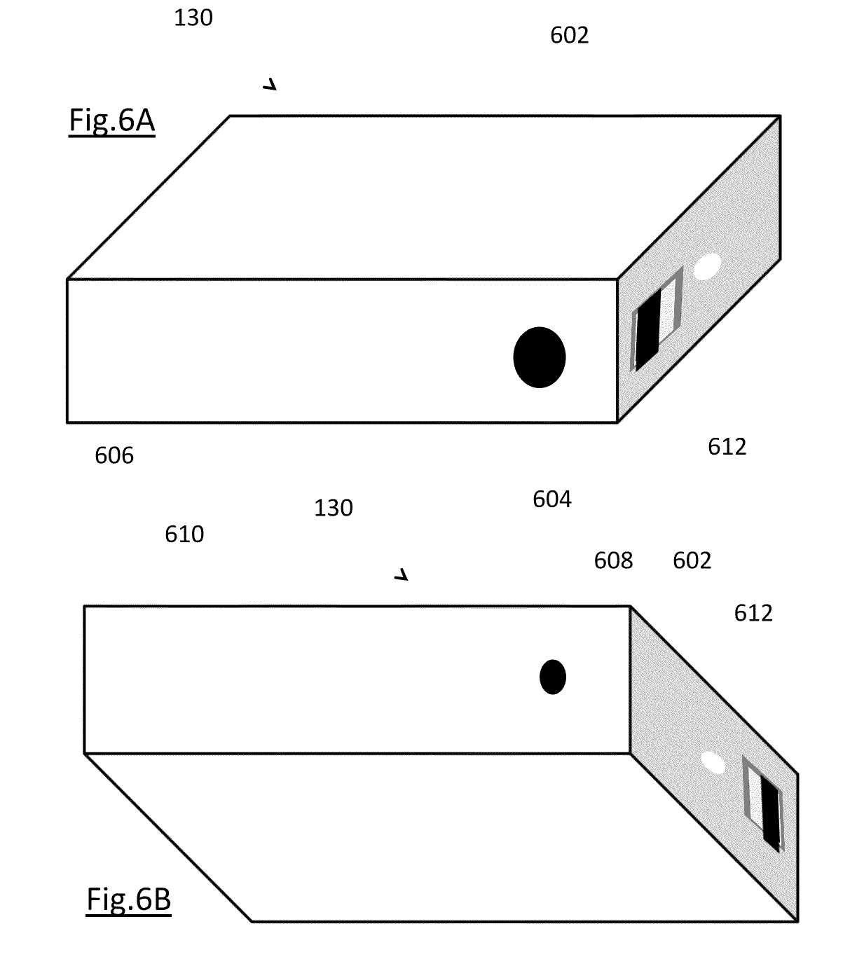

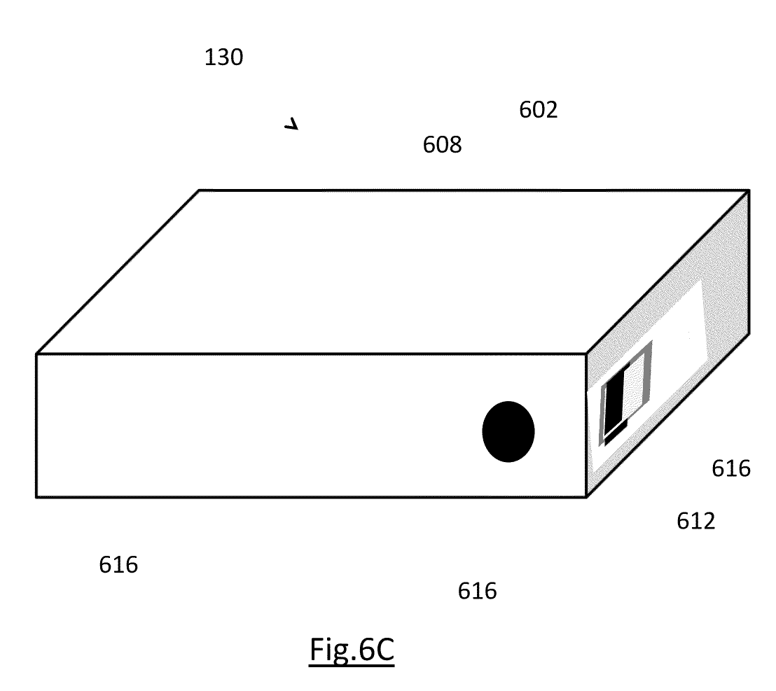

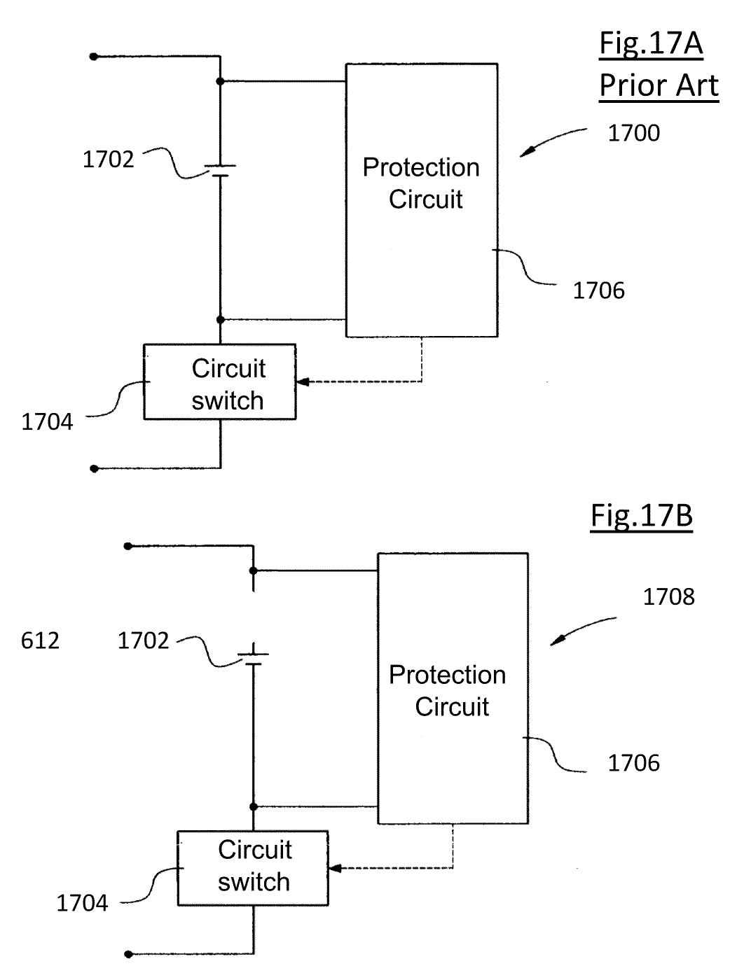

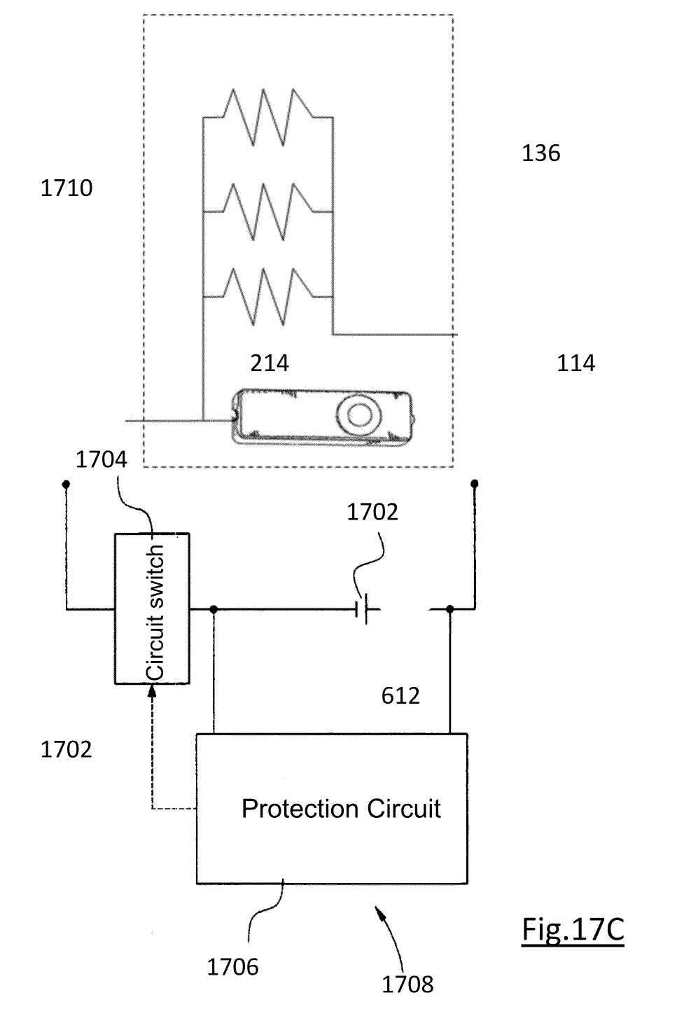

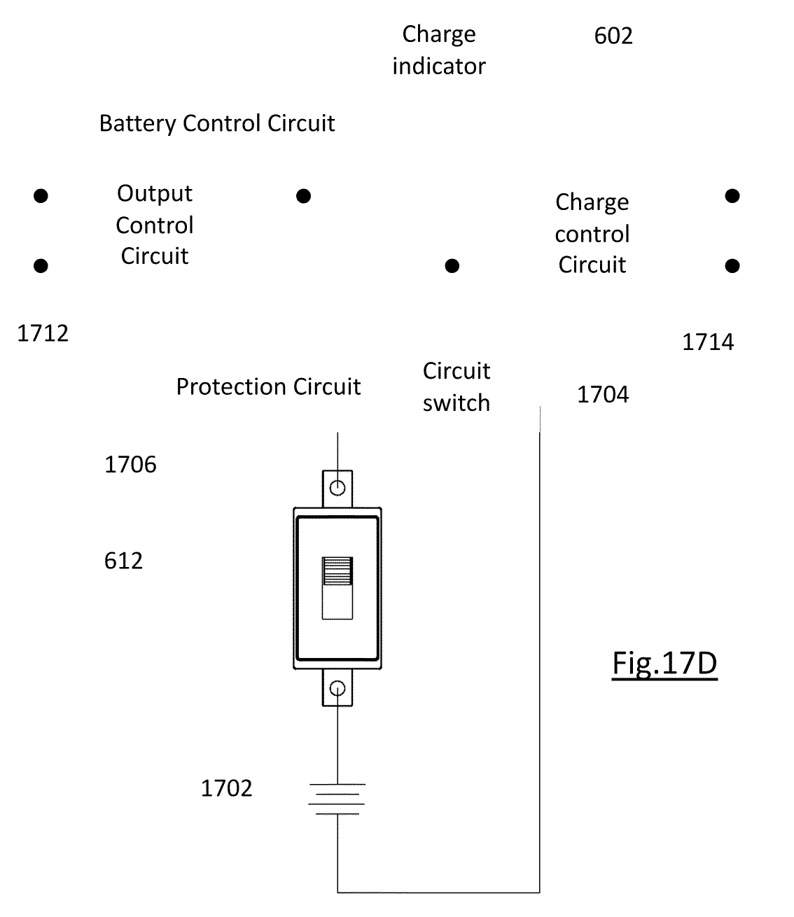

FIGS. 6A, 6B and 6C are schematic views of the battery pack 130 in accordance with the preferred embodiment of the present invention of FIG. 1. They show a six-sided substantially rectangular shaped housing having an aperture being a battery pack charging socket 608 located on a battery pack charging side 610, a differently sized aperture being a battery pack output socket 604 on an opposing battery pack output side 606, and on an adjacent side in the same plane, a battery pack charge indicator light 602 and a first battery pack switch 612. In the preferred embodiment the switch is a high current slide switch having a manufacturer rated load of 6 Amp at 125 Volts AC and a contact resistance of about 30 mΩmax with an operating force of about 4 to 8 Newtons and an insulation resistance of 100MΩmin. Preferably the battery pack charging socket 608 diameter is different to the diameter of the battery pack output socket 604 to reduce the risk of user confusion between the two apertures. The charging socket may include a cover to seal closed the socket the socket is not in use. The housing is preferably sealed and cannot be opened. Disposed on an exposed surface of the battery pack is a user-operable first slide switch 612. The switch 612 may be a slide switch, a push switch or any other switch operable by the user to achieve the same function. When switched to an off position, the switch 612 disconnects power between the battery cell and internal control circuitry as shown in FIG. 17B. This switch 612 in the open or “off” position, prevents both charging and discharging of the battery by a user. In this position, it also disconnects power to a control circuit so as not to drain the battery inside the battery pack 130 when not in use by a user for long periods of time such as 6 to 12 months. When the switch is in the closed or “on” position, it facilitates electrical connections between the battery pack charging socket 608, the internal charging circuit (not shown) and the internal battery cells 1704 (shown in FIG. 17B). When the switch is in the closed or “on” position, it also facilitates electrical connections between the battery cells 1704 (shown in FIG. 17B) and the battery pack output socket 604 via a discharging sub-circuit.

In FIG. 6C the battery pack housing which is made of a rigid polymeric plastic housing has a neoprene battery pack cover 614 sewn over it. A plurality of battery pack cover apertures 616 are sewn into the cover to provide necessary physical access to the battery pack output socket 604, the battery pack charging socket 608, the first battery pack switch 612 and visual access to the battery pack charge indicator light 602. The battery pack cover 616 is preferably made of a resilient insulating material such as neoprene which helps protect the battery pack 130 from a damaging impact shock that may be caused by a user accidentally dropping the battery back 130 on a hard surface. Because the preferred embodiment of the battery pack 130 employs rechargeable lithium technology which can develop cell damage from impacts, the neoprene cover 614 slows down deceleration upon impact thus reducing the force being transmitted to the lithium battery cells. The insulating properties of the neoprene also slow the decline in temperature that the battery pack experiences under cold environments i.e. below freezing (0° F.). Keeping the battery pack 130 at an optimal operating temperature range for a longer time means the battery cells within can maintain their operating charge for longer thus extending the operating time of the heated garment.

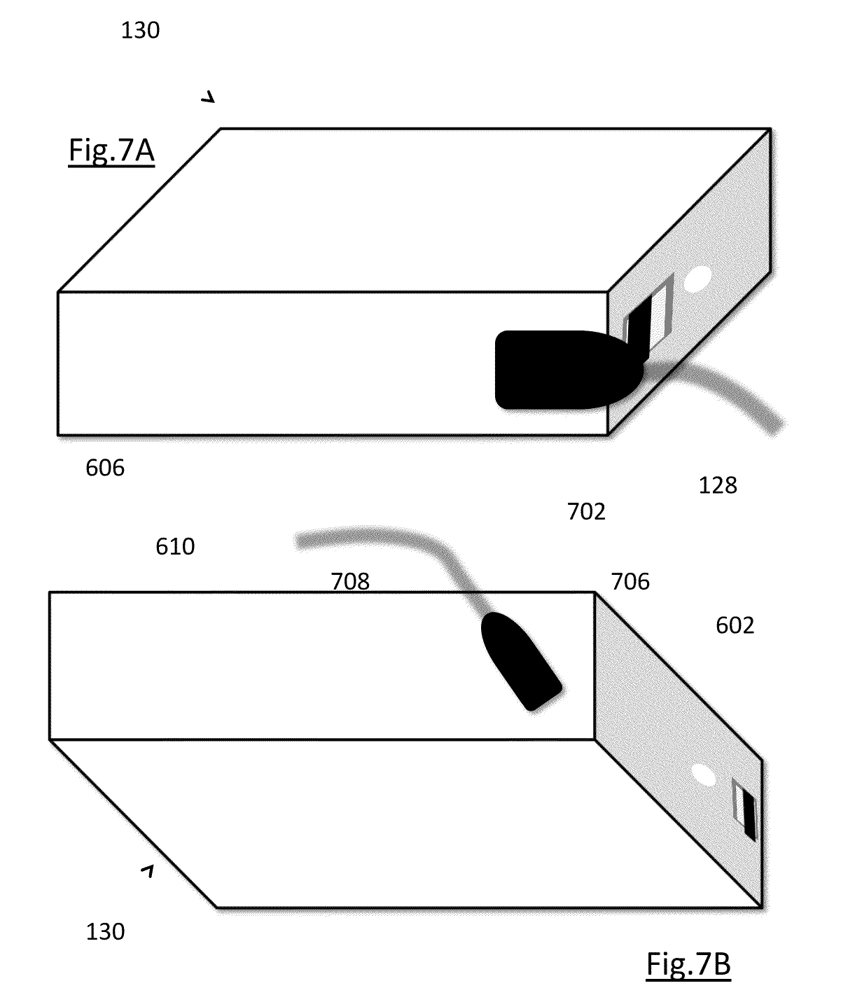

FIG. 7A shows the battery pack 130 of FIG. 6A in use and in accordance with the preferred embodiment of the present invention of FIG. 1A. When in use, a detachable side-entry battery pack output plug 702 is plugged into the battery pack 130 on the battery pack output side 606 via the battery pack output socket 604 shown in FIG. 6A. This battery output plug 702 provides power to the controller 114 (not shown) via the power supply input cable 128.

FIG. 7B shows the battery pack 130 of FIG. 6B when charging in accordance with the preferred embodiment of the present invention of FIG. 1A. When charging, a detachable battery pack charging plug 706 connected to a low voltage direct current power supply is inserted into the battery pack 130 on the battery pack charging side 610 via the battery pack charging socket 608 (shown in FIG. 6B) to charge the battery inside. When charging, the battery pack charge indicator light 602 is illuminated. The light is a bi-color light emitting diode (LED) package. When the battery is charging, the battery pack charge indicator light 602 is illuminated and displays a red color to indicate to the user that current is flowing into the battery cells and that it is charging. When the battery is fully charged, the battery pack indicator LED light 602 displays a green color to indicate to the user the battery is fully charged. When the current-carrying battery pack charging plug 706 is removed from the battery pack charging socket 608, the battery pack charge indicator light 602 ceases to illuminate. Preferably, the battery pack 130 includes a rechargeable lithium polymer battery, and circuitry 1700 (shown in FIG. 17B) to prevent over-temperature, short circuit damage, overcharging and over-discharging of the battery. In this preferred embodiment, the battery pack 130 utilizes a lithium ion polymer technology for its high energy density and light weight. Other embodiments may include a rechargeable lithium ion, or nickel metal hydride or other suitable portable battery technology.

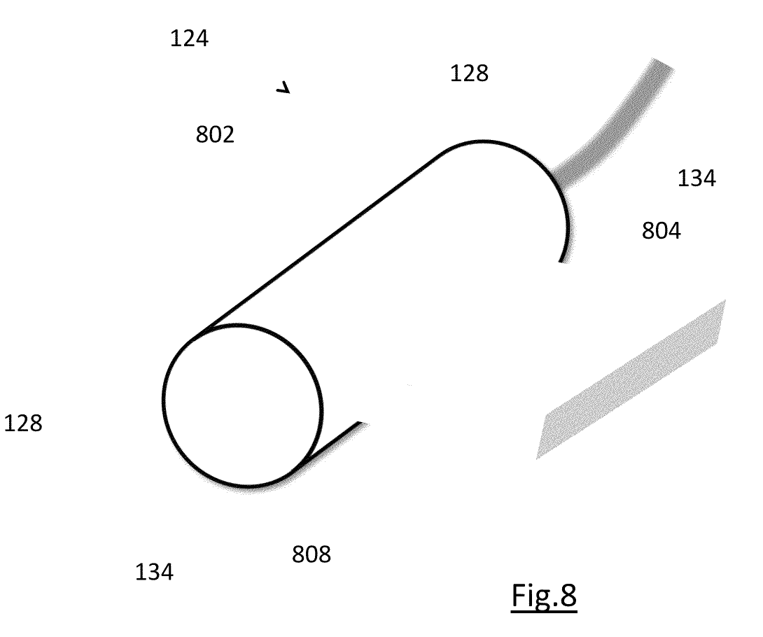

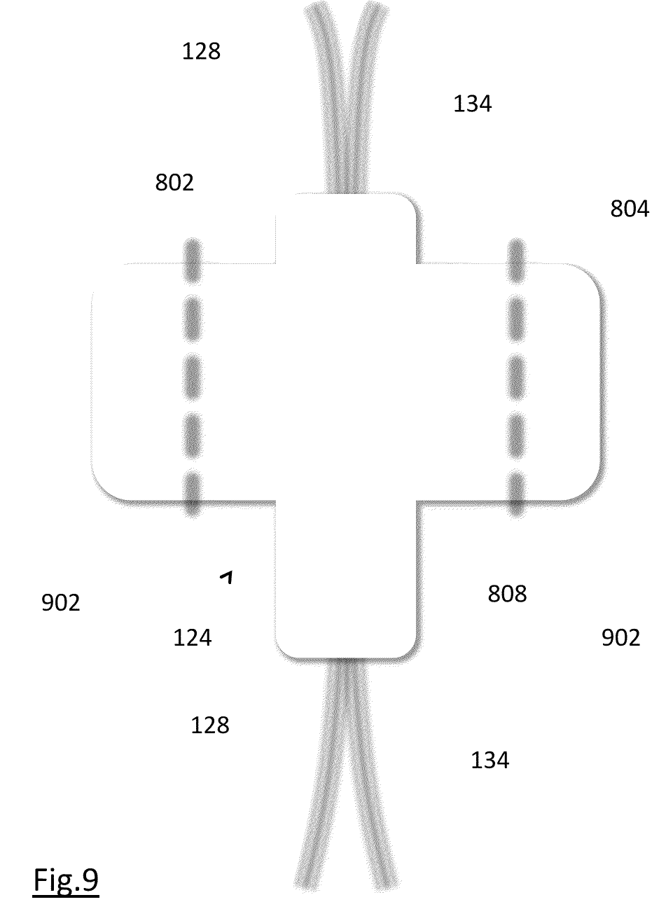

FIG. 8 shows a perspective schematic view of the winged strain relief 124 in accordance with the preferred embodiment of the present invention of FIG. 1A. FIG. 9 shows a schematic view from above of the winged strain relief 124 of FIG. 8. With reference to FIGS. 8 and 9, there is illustrated a strain relief 124 having a 3^{rd} strain relief core 808 formed over a section of one or more cables, preferably the power supply input cable 128 and the heating element power supply cable 134. Formed to both sides of the 3^{rd} strain relief core 808 is a 1^{st} cable strain relief wing 802 and a 2^{nd} cable strain relief wing 804. The cables 128 and 134 have one or more electrical current carrying conductors. The 3^{rd} strain relief core 808 is preferably generally cylindrical and the power supply input cable 128 and the heating element power supply cable 134 are disposed evenly through a center point.

The strain relief 124 is preferably composed of a flexible thermoplastic elastomer rubber or polyvinyl chloride material. The strain relief 124 is made by placing the power supply input cable 128 and the heating element power supply cable 134 inside the bottom half of a hard steel tool, placing or closing the top half of the tool and molding to the power supply input cable 128 and the heating element power supply cable 134.

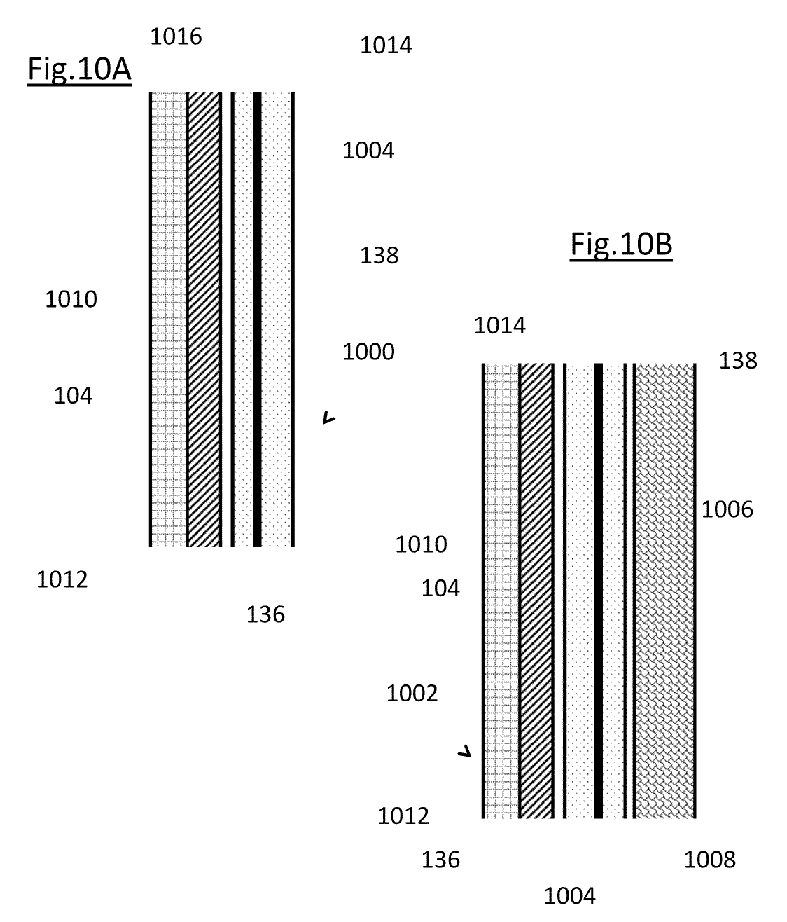

During assembly of the electrical heating parts to the lining 1010, the winged strain relief 124 is affixed onto the lining. Preferably, this is by stitching through the 1^{st} cable strain relief wing 802 and 2^{nd} cable strain relief wing 804 in a direction substantially parallel to the 3^{rd} strain relief core 808 and sewing the 1^{st} cable strain relief wing 802 and 2^{nd} cable strain relief wing 804 to the lining 1010 (as shown in FIG. 10A) of the garment 100 of FIG. 1A via strain relief stitching 902. This strain relief 124 is important for the safety and durability of the garment 100. Without the strain relief 124, excessive pulling by a user of the battery pack output cable 704 that is connected to the garment power output socket 402 via the power supply input cable 128 could result in tearing of the fabric of the garment or dislodging of and damage to the electrical system within the garment 100. Excessive movement of the cables 128 and 134 due to pulling by a user on the garment power input plug 406 is prevented and thus such potential force is prevented from causing damage to the heating element power supply cable 134 or the heating element region 136 by the strain relief 124. Thus the strain relief 124 has two different cables embedded within it being the power supply input cable 128 and the heating element power supply cable 134. The strain relief affords protection for pulling forces with both cables 128 and 134 in both directions. The single dual-cable-use strain relief 124 is preferable to using two discrete strain-relief moldings as it lowers production component cost, reduces the number of items on the production bill of materials, and reduces the electrical-to-garment assembly complexity. However, two single-cabled winged strain reliefs are preferable to none at all.

FIG. 10A is a cross-sectional view of a portion of the preferred embodiment of the present invention of FIG. 1A showing garment layers 1000 having an exterior garment surface 134 and a lining outer surface 104 with a plurality of layers there between. In this preferred embodiment there is a garment outer fabric layer 1004 and a garment inner fabric layer 1016 with a lamination layer 1014 bonded between the garment outer fabric layer 1004 and the garment inner fabric layer 1016. Both the garment outer fabric layer 1004 and the garment inner fabric layer 1016 are manufactured from a low pill polyester fleece fabric and the lamination layer is a thermal polyurethane layer or other wind resistant membrane. There is a fabric lining 1010 having a lining outer surface 104 and a heating element region 136 which is affixed to the fabric lining 1010 preferably via sewing means but may be glued, laminated, welded or other suitable means of fixing. The fabric lining is a heat transmissive fabric such as a thin polyester fabric. The fabric lining 1010 is affixed to the periphery of the garment inner fabric layer 1014 via sewing means may be glued, laminated, welded or other suitable means of fixing. The cross-sectional view shown in FIG. 10A shows the garment inner fabric layer 1014 is not affixed to either the fabric lining 1010 or the heating element region 136 because this view is a cross-sectional view of the garment layers in a region not at the periphery e.g. in the center back region of the garment. The fabric lining is preferably intended to be affixed in a permanent or removably manner to a number of out garment designs and sizes. As such the fabric lining includes an outer perimeter region to facilitate conforming the liner to various garments. The perimeter region may be cut and or hemmed to accommodate variations with the outer garment design.

The garment 100 includes at least two layers. Further, the heated garment 100 may include an insulative garment outer fabric layer 1004, preferably using materials that have a high or dense fiber content that reduce airflow or heat loss. Some materials that may be used include down, Polarguard®, Hallofill, Thinsulate™, Dacron® or wool. The material may also be flame-retardant.

Ideally, a thinner or less insulative material will be used as the lining 104, adjacent the user's body. This facilitates efficient heat transfer from the heating element region 136 to the user's body. Further, a thicker, more insulative material may be used for the garment outer fabric layer 1004. This insulative, thicker outer layer preferably prevents heat from escaping to the outside and allows the garment 100 to be more effective in warming the user.

FIG. 10B is a cross-sectional view of a portion of a second embodiment of the present invention showing garment layers 1002. In this embodiment a water resistant shell garment is included over the outside of the garment layers 1000 such as is employed in the Storm Chaser™ 3-in-1 Jacket mentioned above. The shell has a shell garment fabric 1008 that may be of a water resistant nylon having a shell garment outer face 1006. The shell garment fabric 1006 is preferably detachably affixed to the garment fabric outer layer 1004 at the periphery of the garment such as in the central zipper region, collar and cuffs.

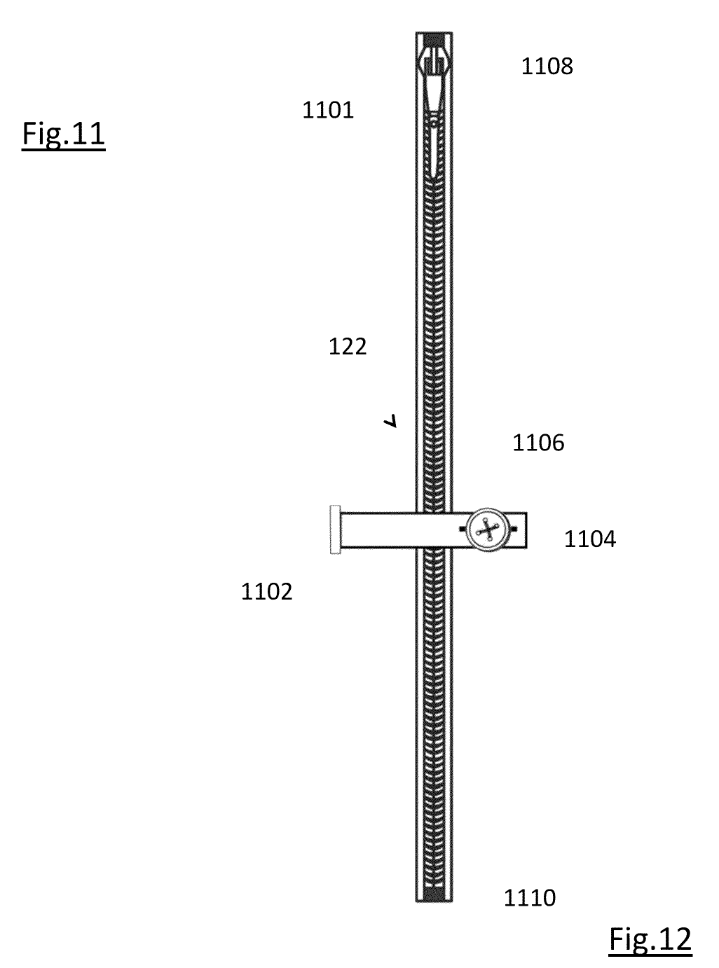

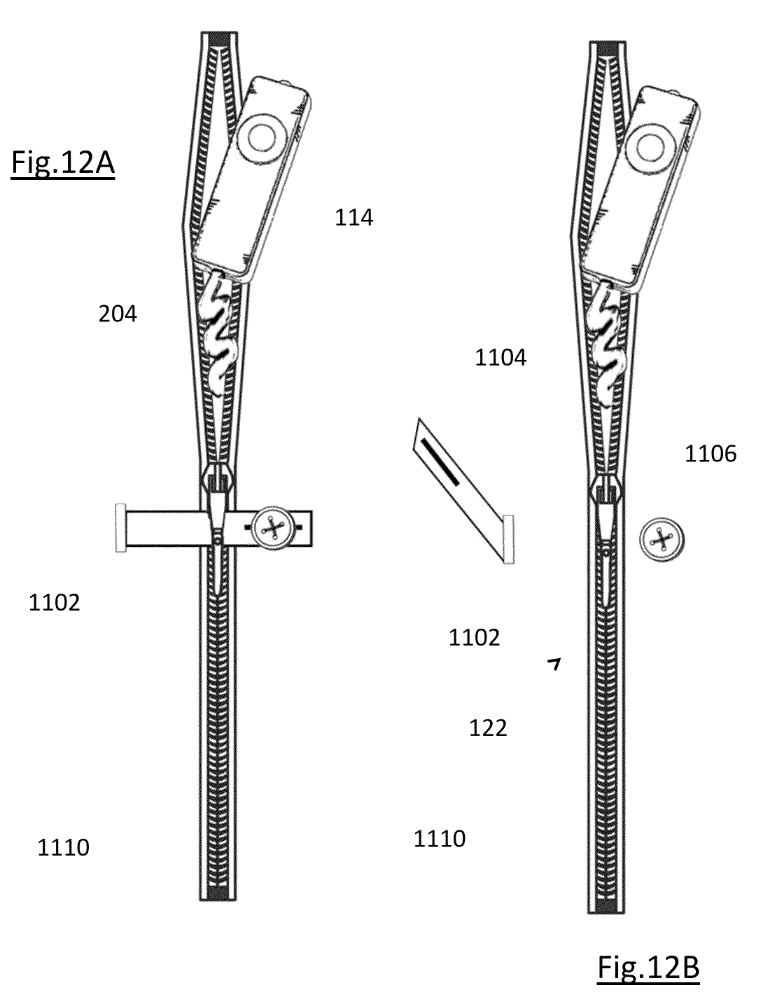

FIGS. 11, 12A and 12B shows schematic views of the controller pocket zipper 122 in accordance with the preferred embodiment of the present invention as shown in FIG. 1B. The controller pocket zipper 122 has a controller pocket zipper top region 1108 where the controller pocket zipper pull 1101 is located when the zipper is fully closed. The controller pocket zipper 122 has a controller pocket zipper bottom region 1110 where the controller pocket zipper pull 1101 is located when the zipper is fully open. The controller pocket zipper 122 has a controller pocket stopper flap 1102 having a stopper flap aperture 1104 for securing to a stopper button 1106 sewn onto the lining of the garment 100. Other methods of securing the flap 1102 may be used such as hook and look closure systems such as Velcro® or any other suitable method. As shown on FIG. 1B, the controller 114 is located in the controller pocket 118. During normal use, unzipping the controller pocket zipper pull 1101 down to the controller pocket zipper bottom region 1110 will cause an excess of the stretchable curly cord cable 204 to be released from the controller pocket 118. It is therefore preferable than only a portion of the controller pocket zipper 122 be opened during normal use to avoid excess cable 204 falling out which can be difficult to put back with the controller 114 into the controller pocket zipper 122 using one hand. However, it is difficult for a user to accurately and repeatedly estimate the appropriate length that the zipper pull 1001 shown be lowered. Accordingly, as shown in FIG. 12A, the controller pocket stopper flap 1102 when secured to the lining surface 104 via the stopper flap aperture 1104 and the stopper button 1106, can only be lowered to a predetermined point along the zipper 122. Lowering only to that point prevents excess cable 204 from exiting the pocket 118 and thus making it easier for a user to place the controller 114 and the cable 204 back in the pocket 118 and zip up the controller pocket zipper pull 1101 to the controller pocket zipper top region 1108. As shown in FIG. 12B, for washing, the controller 114 needs to be removed so the controller pocket stopper flap 1102 is opened and the controller pocket zipper pull 1101 is pulled down to the controller pocket zipper bottom region 1110 thereby fully opening the pocket 118 and exposing the controller power output socket 208, the controller power input plug 210, the garment power output socket 402 and the garment power input plug 406 to enable separation of the controller power output socket 208 and the controller power input plug 210 from the garment power output socket 402 and garment power input plug 406 respectively (as shown in more detail in FIG. 5).

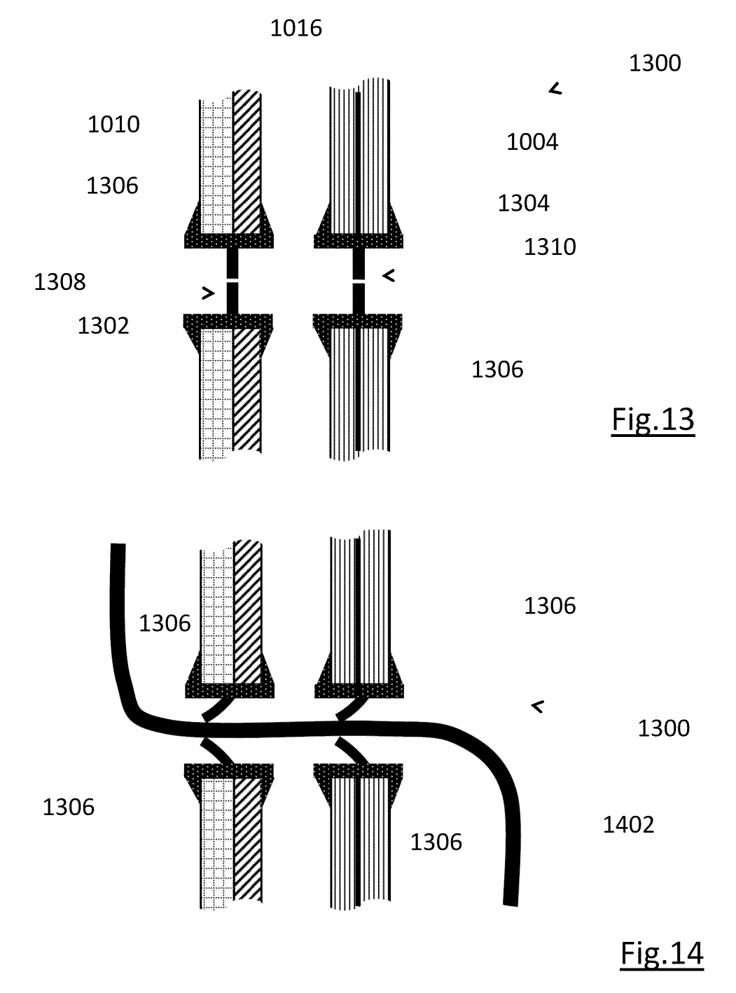

FIGS. 13 and 14 show a cross-sectional view of the garment 100 in accordance with a third embodiment of the present invention shown in FIG. 1. Specifically, FIGS. 13 and 14 show a garment aperture region 1300 that has an inner fabric aperture 1308 creating an opening in fabric lining 1010 and an outer fabric aperture 1310 creating an opening in the garment inner fabric layer 1016 and the garment outer fabric layer 1004. Disposed within the inner fabric aperture 1308 is an inner cabling grommet 1302 having at least one resilient flap 1306. Disposed within the outer fabric aperture 1310 is an outer cabling grommet 1304 having at least one resilient flap 1306. The resilient flaps 1306 reduce airflow into and out of the garment to retain the insulating properties of the garment. As shown in FIG. 14, when an accessory cabling 1402 such as used for audio headphones is passed through grommets 1302 and 1310, the resilient flaps 1306 flex to allow passage of the accessory cabling but still retain their insulating properties. In an alternate embodiment, the inner fabric aperture 1308 is located and accessible within the controller pocket 118 of FIG. 1B and generally aligns with the outer fabric aperture 1310 being located within and accessible via the external upper left napoleon pocket 310 of FIG. 3A. Further, the accessory cabling 1402 may be a portion of the stretchable curly cord cable 204 of the controller 114 of FIG. 2 thus positioning the controller user operable switch 214 so as to be accessible via the interior external upper left napoleon pocket 310.

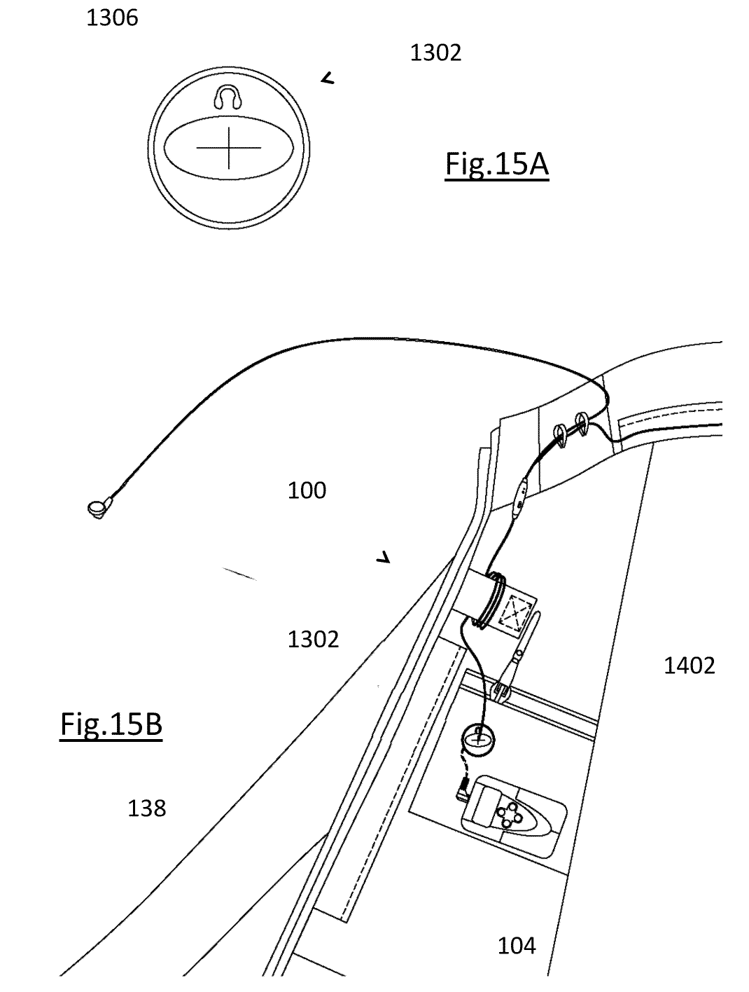

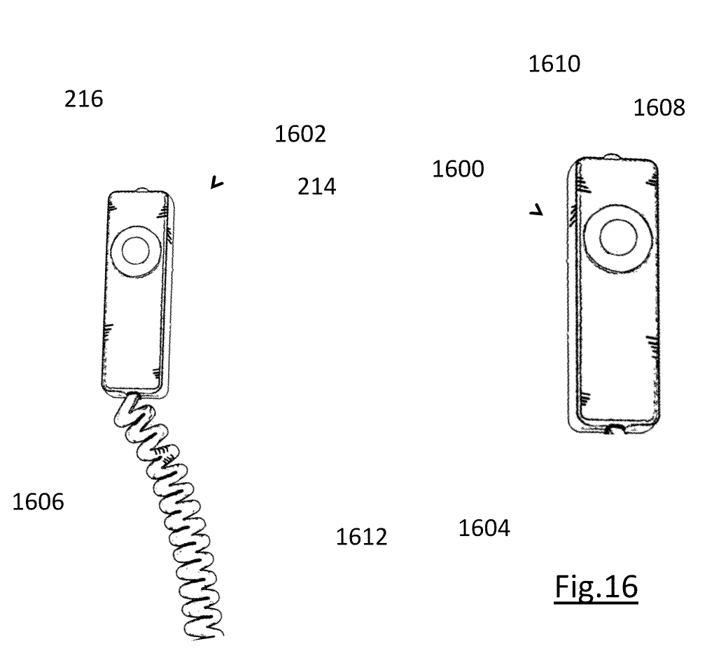

As shown in FIG. 15A, the inner cabling grommet 1302 may be round shaped having centrally opening flaps 1306. The outer cabling grommet 1304 is identical to the inner cabling grommet 1302. The inner cabling grommet may be made from a resilient plastic or rubber.

FIG. 15B shows the inner cabling grommet 1302 affixed into the lining outer surface 104 of the garment 100 with accessory cabling 1402 passing though the grommet 1302. Preferably the grommet 1302 is sewn onto the lining outer surface 104.

FIG. 16 is a schematic view of a wireless controller in accordance with a fourth embodiment of the present invention of FIG. 1. It shows a wireless remote receiver controller 1602 which receives control signals from a wireless remote transmitter controller 1600 via radio frequency communication waves 1612. The wireless remote transmitter controller 1600 has a receiver housing 1604 made from a thermoplastic material. Disposed on the transmitter housing 1604 is a transmitter button 1608 and a transmitter indicator light 1610. The wireless remote receiver controller 1602 has a transmitter housing 1606 made from a thermoplastic material. Disposed on the receiver housing 1606 is a controller user operable switch 214 for local control and a controller indicator light 216 with functions as shown in FIG. 2. Disposed within the receiver housing 1606 is an antenna and radio frequency receiver circuitry (not shown) to receive the coded control signals from the wireless remote transmitter controller 1600 via radio frequency communication waves 1612. The wireless remote transmitter controller 1600 includes transmitter circuitry (not shown) to convert the electrical signals into radio frequency communication waves 1612 that can be decoded by the wireless remote receiver controller 1602.

FIG. 17A shows prior art circuitry 1700 for a rechargeable lithium battery cell 1702. A rechargeable lithium battery 1702 is preferable in the application of heated apparel due to its high energy density and wide range of operating temperatures. However, if a rechargeable lithium battery is charged with an over-voltage current, there will be an increased risk of an explosion of the battery cell 1702. On the other hand, if the rechargeable lithium battery cell 1702 is discharged to an excessively low voltage, where the rechargeable lithium battery cell 1702 voltage is lower than the preferred normal voltage range, the useful life of use of the rechargeable lithium battery cell 1702 will be shortened. Therefore, rechargeable lithium battery packs generally include a protection device 1706 as shown in FIG. 17A for its use (during charging or discharging).

It includes protection circuitry 1700 comprising a battery cell 1702 connected to a protection integrated circuit (IC) 1706 and a circuit switch 1704. If the protection IC 1706 is charged or discharged, the voltage of the rechargeable lithium battery cell 1702 will be detected. If an abnormal voltage of the rechargeable lithium battery cell 1702 is detected, the protection IC 1706 will send a signal to the circuit switch 1704 to disconnect the charging current to the cell and the discharging current from the cell. The sub-circuitry to disconnect power to the supplied device, in this case a heated garment, due to over-discharge of the cell requires power to be supplied to the IC 1706 to monitor the battery cell voltage. Over time, this power used by the IC 1706 will eventually drain the battery cell 1702. Storage of most lithium secondary cells in a heavily discharged state over a long period of time will reduce the ability of the cell to recharge to its rated capacity. This is especially a problem when the cells are only used seasonally. For example, in the Northern hemisphere, a user may regularly charge up the cell from December through March as they use the heated garment during these colder winter months. However, as the weather warms up into spring they have no use for a heated garment and so are not regularly charging the cells for use. They will not regularly have an operational need to recharge the cell for the entire spring, summer and fall months which may be a time period of up to eight months. Accordingly it is likely they may forget to charge the cell 1702 for cell maintenance reasons on a regular basis e.g. every 2 months. When they finally charge the cell 1702 some eight months later because they wish to use the heated garment, it is likely the cell 1702 will not charge and operate to its rated capacity specifications. Accordingly there is a need to extend the storage life of the cell 1702.

FIG. 17B shows an improved battery circuit 1708, wherein the circuit 1700 in FIG. 17A has been modified to include the user operable switch 612 to disconnect power between the battery cell 1702 and the circuit 1706. This switch 612 when in the open position, prevents both charging and discharging of the device by a user. In this position, it also disconnects power to the IC 1706 which is not needed when the user cannot either charge or discharge the cell 1702. Thus, when the user charges up the battery pack at the end of winter and moves the switch 612 to the “off” or open position, the circuit is “broken” and the self-discharge of the battery pack will be minimized by removing any power drain by the control circuitry, which in this embodiment is condensed into an integrated circuit 1706.

FIG. 17C shows a partial schematic and circuit diagram of the heating system in accordance with the preferred embodiment of the present invention as shown in FIGS. 1 and 17B further disclosing the controller 114 having a controller user operable switch 214 that is operated by a user to switch between different heating levels. It shows the controller 114 connected to the resistive heating elements 136 which are preferably connected in parallel through the controller 114 to at least one rechargeable battery cell 1702.

FIG. 17D is a functional block diagram of the battery and battery control circuit of FIGS. 6A-C showing the battery pack charge indicator light 602 connected to the battery control circuit between the battery protection circuit 1706 and charge control circuit 1714. The output control circuit connects in parallel to the indicator from the protection circuit that in turn connects to the battery positive terminal via a switch 612. Switch 612 creates an open circuit that disconnects all loads internal to the battery pack from the battery allowing for prolonged storage of the battery with minimal discharge. The switch allows for hibernation of the battery during the warmer months when the heating system is not utilized and is stored. Use of the switch is believed to increase the life cycle and operating hours of the battery. The return path to battery ground from the output control circuit and the charge control circuit is through electronic circuit switch 1704. The output control circuit connects to the output socket 608 (FIGS. 6A-C) and the charge control circuit connects to the charging socket 608 (FIGS. 6A-C). With continued reference to FIG. 17D, when the first battery pack switch 612 is on closed or “ON” position, power to the battery pack load output 1712 is enabled from the rechargeable battery cell 1702. Also, when the first battery pack switch 612 is on closed or “ON” position, power is enabled from the charging sub-circuit 1714 to the rechargeable battery cell 1702. The first battery pack switch 612, when in the open position or “OFF” position, prevents power from supplying the battery pack load output 1712 and prevents power from reaching the rechargeable battery cell 1702 from the to the charging sub-circuit 1714. It will further be appreciated that by including the battery charge control circuit within the battery pack that a user cannot harm the battery 1702 by using an electrically incompatible charger.

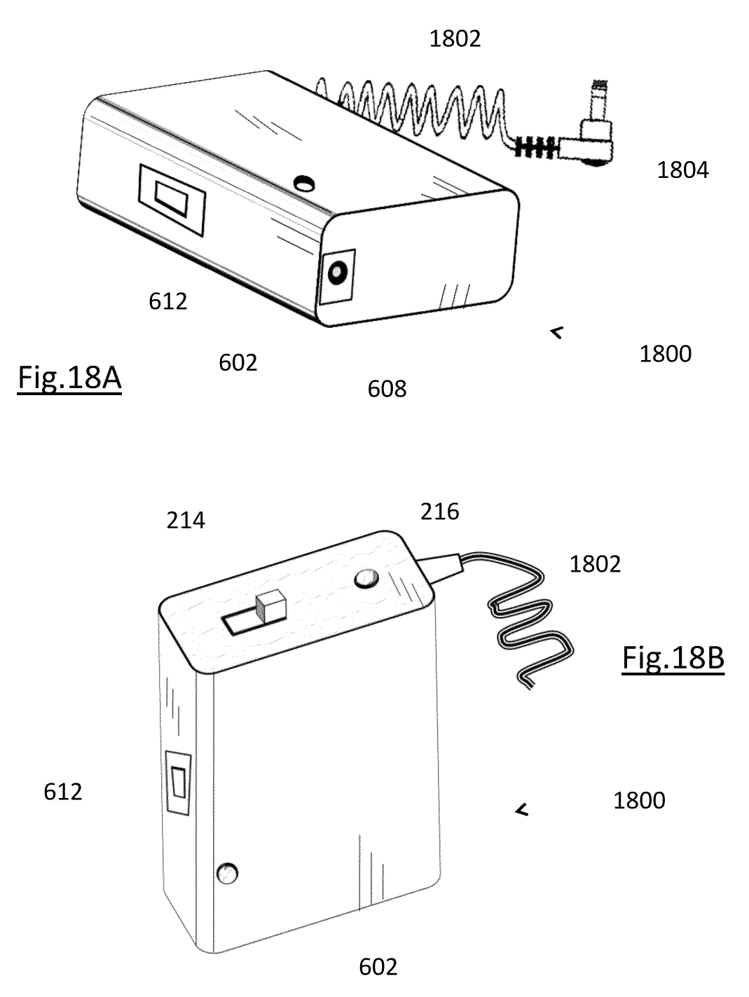

FIGS. 18A and B are schematic views of an alternate battery pack 1800. This alternate battery pack 1800 is preferably utilized where space is constrained and the functions of the controller 114 are integrated into the battery pack housing. This is most desirable when the alternate battery pack 1800 is attached to the arm of a user to provide power to heated gloves or attached to the leg of the user to provide power to heated socks.

They show a six-sided substantially rectangular shaped housing having an aperture being a battery pack charging socket 608 located on a lower face of the alternate battery pack 1800, a battery pack output cable 1804 connected to a battery pack output plug 1802 a battery pack charge indicator light 602, a first battery pack switch 612, a controller user operable switch 214 and a controller indicator light 216 to show heating levels selected by a user through use of the controller user operable switch 214. In this embodiment the switch is a high current slide switch having a manufacturer rated load of 6 Amp at 125 Volts AC and a contact resistance of about 30 mΩmax with an operating force of about 4 to 8 Newtons and an insulation resistance of 100 MΩmin. Disposed on an exposed surface of the battery pack is a user-operable first battery pack slide switch 612. The switch 612 may be a slide switch, a push switch or any other switch operable by the user to achieve the same function. When switched to an off position, the switch 612 is disconnects power between the battery cell and internal control circuitry as shown in FIG. 17B. This switch 612 in the open or “off” position prevents both charging and discharging of the battery by a user. In this position, it also disconnects power to a control circuit so as not to drain the battery inside the battery pack 1800 when not in use by a user for long periods of time such as 6 to 12 months. When the first battery pack switch is in the closed or “on” position, it facilitates electrical connections between the battery pack charging socket 608, the internal charging circuit (not shown) and the internal battery cells 1704 (shown in FIG. 17B). When the switch is in the closed or “on” position, it also facilitates electrical connections between the battery cells 1704 (shown in FIG. 17B) and the battery pack output plug 1802 via a discharging sub-circuit.

When the first battery pack switch is in the closed or “on” position and when the controller user operable switch 214 is slid to a first position, the controller indicator light 216 illuminates and displays a red color. Internally, a circuit within the controller housing 212 allows a maximum predetermined current to pass from battery cell 1702 out through the battery pack output plug 1802 to the heating elements. This is termed the “HIGH” level of heat setting the controller user operable switch 214 is slid to a second middle position, the controller indicator light 216 illuminates and displays a green color. Internally, the circuit within the battery pack 1800 emits a lower current passing out through the battery pack output plug 1802 to the heating elements. This is termed the “LOW” level of heat setting. When the controller user operable switch 214 is slid to a third position, the controller indicator light 216 ceases to illuminate. Internally, the circuit within the battery pack 1800 cuts the current flowing to the heating elements. This is termed the “OFF” setting. Different battery pack forms are envisaged that may be suitable for heated clothing, heated headwear, heated cushions, heated body wraps and supports, and heated blankets.

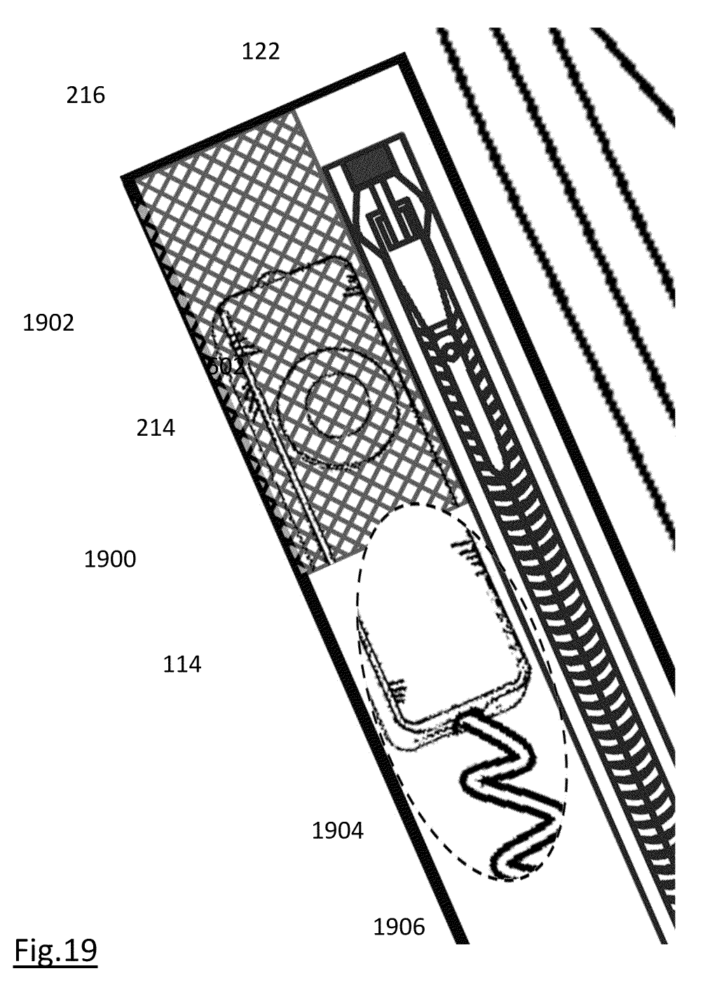

In an alternate controller pocket embodiment (FIG. 19), The controller 114 is disposed in a pocket 1900 having a zippered 122 opening and cavity 1904 for holding the controller. However, the zipper can remain closed during use as a portion of the pocket includes a light and touch transmissive material 1902 that allows for the user to see the indicator 216 of the controller and operate the controller interface 214 through the material. The material can include, but is not limited to, mesh, thin nylon or translucent plastic. The material can cover all of the pocket outer surface or merely a portion of the pocket outer surface sufficient to allow the light to transmit there through.

The preferred embodiment is a thermal garment 100 adapted for being worn on a body of an individual having a first open end for receiving a body portion of a wearer and a second open end for a portion of that body portion to pass through. The thermal garment 100 has a fabric lining 1010 having a perimeter, at least one flexible heating element 136 attached to the fabric lining 1010, a power supply connector 702 attached to the fabric lining 1010, with the power supply connector being in communication with the heating element and where the power supply connector is accessible inwardly with respect to an inward facing layer of lining 104. The garment also includes a user-operable controller 114 removeably attached to the lining in communication with the heating element and the power supply connector for controlling power supplied via the power supply connector to the heating element 136 to vary temperature. The controller 114 is accessible inwardly with respect to an inner facing layer of lining 104. The garment 100 also includes an external garment outer fabric layer 1004 having an insulating fabric such as laminated polyester fleece, and has a first open end for receiving a body portion of a wearer and a second open end for a portion of that body portion to pass through. The garment outer fabric layer 1004 is preferably non-releasably attached to the fabric lining 1010 around a substantial portion of the perimeter of the fabric lining 1010. In this way a garment assembly may be created by allowing for the liner to be interchangeably integrated with a number of separately manufactured jacket outer layers.

In the preferred embodiment, the heating element 136 is a plurality of flexible carbon fiber conductors formed loosely into at least one discrete bundle, with these conductors being operable to generate heat in response to current flowing there through. These conductors are sewn onto a non-exposed part of the fabric lining 1010 and constitute a heating zone.

The garment 100 further includes a rechargeable battery 130 removably attached to the battery pack output plug 702. The battery 702 is in communication with the heating element 136 via the pack output plug 702. The battery 702 is accessible inwardly with respect to an inward facing layer of lining being the lining outer surface 104.

As indicated in FIG. 10B, a second embodiment of the present invention includes a garment with an external fabric layer 1004 including a vertical lining zipper and further having a detachable outer shell garment that has a vertical shell zipper, the outer shell 1008 being removably attached to the outer fabric layer 1004 by zippering the lining zipper to the shell zipper.

A list of numbers and the objects they refer to in the drawings is detailed below:

| | |
|---|---|
| 100 | garment |
| 102 | sleeve |
| 104 | lining outer surface |
| 106 | collar |
| 108 | lining pocket |
| 110 | hem |
| 112 | tightening cord |
| 114 | controller |
| 118 | controller pocket |
| 120 | lower controller pocket region |
| 122 | controller pocket zipper |
| 124 | winged cable strain relief |
| 128 | power supply input cable |
| 130 | battery pack |
| 132 | battery pack pocket opening |
| 134 | heating element power supply cable |
| 136 | heating element region |
| 138 | exterior garment surface |
| 202 | controller body |
| 204 | stretchable curly cord cable |
| 206 | controller heat shrink |
| 208 | controller power output socket |
| 210 | controller power input plug |
| 212 | controller housing |
| 214 | controller user operable switch |
| 216 | controller indicator light |
| 218 | controller power input plug tip |
| 220 | controller power output socket aperture |
| 222 | controller power input plug aperture |
| 302 | External front garment face |
| 304 | External back garment face |
| 306 | External lower left hand pocket |
| 308 | External lower right hand pocket |
| 310 | External upper left napoleon pocket |
| 312 | External upper right napoleon pocket |
| 402 | garment power output socket |
| 404 | garment power output socket aperture |
| 406 | garment power input plug |
| 408 | garment power input plug tip |
| 410 | garment power output socket cap |
| 412 | garment power output cap retainer loop |
| 414 | garment power input cable strain relief |
| 602 | battery pack charge indicator light |
| 604 | battery pack output socket |
| 606 | battery pack output side |
| 608 | battery pack charging socket |
| 610 | battery pack charging side |
| 612 | first battery pack switch |
| 614 | Battery pack cover |
| 616 | Battery pack cover apertures |
| 702 | battery pack output plug |
| 704 | battery pack output cable |
| 706 | battery pack charging plug |
| 708 | battery pack charging cable |
| 802 | 1st cable strain relief wing |
| 804 | 2nd cable strain relief wing |
| 808 | 3rd cable strain relief core |
| 902 | strain relief stitching |
| 1000 | garment layers |
| 1002 | shell garment layers |
| 1004 | garment outer fabric layer |
| 1006 | shell garment outer surface |
| 1008 | shell garment fabric |
| 1010 | fabric lining |
| 1014 | Lamination layer |
| 1016 | Garment inner fabric layer |
| 1012 | heating element inner surface |
| 1101 | Controller pocket zipper pull |
| 1102 | Controller pocket stopper flap |
| 1104 | Stopper flap aperture |
| 1106 | Stopper button |
| 1108 | Controller pocket zipper top region |
| 1110 | Controller pocket zipper bottom region |
| 1300 | Garment aperture region |
| 1302 | Inner cabling grommet |
| 1304 | Outer cabling grommet |
| 1306 | Resilient flap |
| 1308 | Inner fabric aperture |
| 1310 | Outer fabric aperture |
| 1402 | Accessory cabling |
| 1600 | Wireless remote transmitter controller |
| 1602 | Wireless remote receiver controller |
| 1604 | Transmitter housing |
| 1606 | Receiver housing |
| 1608 | Transmitter button |
| 1610 | Transmitter indicator light |
| 1612 | Radio frequency communication waves |
| 1700 | circuitry for a rechargeable lithium battery cell |
| 1702 | Rechargeable lithium battery cell |
| 1704 | Circuit switch |
| 1706 | Protection integrated circuit |
| 1708 | Improved battery circuit |
| 1710 | Heating Load sub-circuit |
| 1712 | Battery pack load output |
| 1714 | Charging sub-circuit |
| 1800 | Alternate battery pack |
| 1802 | Battery pack output plug |
| 1804 | Battery pack output cable |

Although the invention has been described in language specific to structural features and/or methodological acts, it is to be understood that the invention defined herein is not necessarily limited to the specific features or acts described. Rather, the specific features and acts are disclosed as exemplary forms of implementing the claimed invention.

What is claimed is:

1. A garment assembly comprising:
an outer layer selected from any separately manufactured outer layer;
a liner covering an inner surface of said outer layer including:
a fabric layer;
at least one flexible heating element affixed to said fabric layer;
a controller electrically connected to said heating element;
a portable power supply electrically connected to said controller and said heating elements;
electrical leads affixed to said fabric layer to provide an electrical connection between said portable power supply, said controller and said at least one heating element; and
at least one closeable pocket for housing said controller and said portable power supply.

2. The garment assembly of claim 1 wherein:
said liner includes a perimeter for affixing said liner to said outer layer.

3. The garment assembly of claim 2 wherein said perimeter includes an excess portion of said fabric layer to conform said liner for attachment to said outer layer.

4. The garment assembly of claim 3 wherein conforming said liner size along said perimeter by hemming or cutting away a portion of said perimeter.

5. The garment assembly of claim 3 wherein said liner is affixed to said outer layer.

6. The garment assembly of claim 5 wherein said liner is affixed by sewing to said outer layer to form a seam.

7. The garment assembly of claim 5 wherein said liner and said outer layer are removably affixed by fasteners consisting of the group selected from a zipper, buttons, hook and loop material and any combination thereof.

8. The garment assembly of claim 1 wherein said at least one pocket includes an adjustable opening having a first opening size for accessing said controller during operation and a second opening size for insertion and connection said controller.

9. The garment assembly of claim 8 wherein said adjustable opening includes a stop flap to prevent opening to said second opening size.

10. The garment of claim 8 wherein said at least one pocket is two pockets with a first pocket sized to hold said battery and a second pocket is sized to hold said controller.

11. The garment of claim 10 wherein said second pocket is an inner breast pocket to facilitate access to said controller.

12. An inner liner for attachment to an outer garment layer comprising:
a fabric layer;
a heated garment circuit having:
at least one flexible heating element affixed to the fabric layer;
a controller electrically connected to the heating element;
a portable power supply electrically connected to the controller and the heating elements; and
electrical leads affixed to the fabric layer to provide an electrical connection between the portable power supply, the controller and the at least one heating element; and
at least one closeable pocket for housing one of the controller and the portable power supply
wherein said heated garment circuit is provided independent of said outer garment layer.

13. The inner layer of claim 12 further including a plurality of strain reliefs to protect the integrity of the electrical circuit.

14. The inner layer of claim 12 wherein said at least one heating element is a plurality of flexible carbon fiber conductors formed loosely into at least one discrete bundle.

15. The inner layer of claim 13 wherein a strain relief is affixed to the inner layer and electrical leads extending between components selected from the group consisting of the controller and the portable battery supply, the heating element and the portable battery supply, the controller and the heating element and any combination thereof.

16. The inner layer of claim 13 wherein a first cable plug and socket in an electrical lead from said controller and said at least one heating element allow for disconnection of said controller from said at least one heating element and strain reliefs are provided at a junction of the electrical leads to the socket and the plug; and
wherein a second cable plug and socket in an electrical lead from said controller and said portable power supply allow for disconnection of said controller from said portable power supply and strain reliefs are provided at a junction of the electrical leads to the socket and the plug.

17. The inner layer of claim 16 wherein at least one of said cable plugs and sockets include a water resistant cap.

18. The inner layer of claim 12 wherein said at least one pocket further includes a first pocket for housing said portable power supply and a second pocket having a closeable opening for holding said controller, said closeable opening includes two opening positions where a first opening position is large enough for access to the controller and a second opening position is large enough for insertion and connection of the controller to said electrical leads.

19. The inner layer of claim 18 wherein an opening stop is disposed along said closeable opening to prevent opening of said closeable opening beyond said first opening position.

20. The inner layer of claim 12 further including a first pocket for housing said portable power supply and a second pocket having a closeable opening for holding said controller, a portion of said pocket wall includes a light transmissive material for feedback from said controller.

21. The inner layer of claim 12 wherein said portable power supply is a battery pack having a housing enclosing a battery and a battery control circuit, the battery pack further includes a switch located between the battery and battery control circuit that is operative to, during long periods of non-use, create an open circuit between the battery and the battery control circuit; and
wherein said controller further includes a switch to control power from the battery to the heating element during normal use.

22. A rechargeable battery pack for seasonal use in a heated garment comprising:
at least one battery;
a battery control circuit having a current drain on said at least one battery;
a self-contained housing for enclosing the battery and battery control circuit;
a switch located between the battery and battery control circuit operative to, during long periods of non-use, create an open circuit between the battery and the battery control circuit.

23. The rechargeable battery pack of claim 22 in combination with said heated garment wherein said heated garment includes at least one heating element.

24. The rechargeable battery pack of claim 22 wherein said battery is a lithium battery.

25. The rechargeable battery pack of claim 22 wherein said heated garment includes at least one heating element and said switch is not used during operation of said heated garment to activate said at least one heating element.

26. The rechargeable battery pack of claim 22 wherein said self-contained housing is covered with a material that attenuates impact to contents of said self-contained housing.
